(19) United States
(12) Patent Application Publication
(10) Pub. No.: US 2025/0315365 A1
(43) Pub. Date: Oct. 9, 2025

(54) COMPUTING SYSTEMS AND METHODS FOR IDENTIFYING SOFTWARE TEST CASES USING NATURAL LANGUAGE PROCESSING

(71) Applicant: The Toronto-Dominion Bank, Toronto (CA)

(72) Inventors: Ashish KAUL, Oakville (CA); Pranav Kumar VANGIPURAPU, Burlington (CA); Aayush KATHURIA, Brampton (CA); Jaskaran SINGH, Etobicoke (CA)

(21) Appl. No.: 18/625,319

(22) Filed: Apr. 3, 2024

(51) Int. Cl. G06F 11/36

(52) U.S. Cl. CPC G06F 11/3684; G06F 11/3698

(57) ABSTRACT

A server system for identifying test cases is provided. The server system obtains a group of test cases, each test case including a name, a description and one or more steps for testing. For each test case, the server system processes at least the description and the one or more steps using a Natural Language Processing (NLP) pre-trained model to output a vector of numerical values across n-number of dimensions. The server system compiles a group of vectors corresponding to the group of test cases. The server system applies a clustering process to the group of vectors to identify a subset of vectors from the group of vectors. The server system then outputs a subset of test cases corresponding to the subset of vectors.

### TECHNICAL FIELD

The disclosed exemplary embodiments relate to computer-implemented systems and methods for identifying software test cases using natural language processing (NLP) models.

### BACKGROUND

In some cases when developing software, a test case is developed that includes a text specification of the inputs, execution conditions, testing procedure, and expected results. This specification for a test case defines a single test to be executed to achieve a particular software testing objective, such as to exercise a particular program path or to verify compliance with a specific requirement.

When developing software, hundreds of test cases can be developed, or sometimes thousands of test cases can be developed. In some cases, executing a given test case is automated using software. In some other cases, a user manually executes a given test case. In either case, executing test cases is time intensive and requires computing resources (e.g., processor and memory resources). Therefore, in many cases in the software development industry, software developers (i.e., people) will manually select and prioritize the test cases to be performed. This is inconsistent and prone to subjectivity and error. In some cases, for large software applications, the process of selecting and prioritizing test cases could take approximately two weeks for software testing personnel.

### SUMMARY

The following summary is intended to introduce the reader to various aspects of the detailed description, but not to define or delimit any invention.

In at least one broad aspect, a server system for identifying test cases is provided. The server system includes a memory storing a Natural Language Processing (NLP) pretrained model, a network interface, and a processor, and the processor is operably coupled to the memory and the network interface. The processor is configured to at least:
obtain a group of test cases, each test case comprising a name, a description and steps for testing;
for each test case, process at least the description and the steps using the NLP pre-trained model to output a vector of numerical values across n-number of dimensions;
compile a group of vectors corresponding to the group of test cases;
apply a clustering process to the group of vectors to identify a subset of vectors from the group of vectors; and
output a subset of test cases corresponding to the subset of vectors.

In some cases, the processor is also configured to process at least the description and the steps of a given test case using the NLP pre-trained model by at least: obtaining a word vector for each word in the description and the steps; computing a sum of the word vectors, then divide the sum by a number of words in the description and the steps to obtain a resulting vector; and, returning the resulting vector as the vector of the given test case.

In some cases, if a new word in the description and the steps is not part of a vocabulary library of the NLP pre-trained model, then the processor is also configured to: generate a unique random word vector corresponding to the new word and store the new word and the unique random word vector in an Out-Of-Vocabulary library in the NLP pre-trained model.

In some cases, the subset of vectors is a predetermined number stored in the memory.

In some cases, the memory also stores a graphical user interface (GUI) that includes a GUI element operable to receive a desired number of test cases, and the desired number of test cases is inputted into the clustering process to determine the subset of vectors, where a number of the subset of vectors matches the desired number of test cases.

In some cases, the memory also stores a GUI that includes a first GUI element operable to receive a file that comprises the group of test cases, and a second GUI element to operable to receive a desired number of test cases.

In some cases, the processor is also configured to automatically determine a total number of test cases in the group of test cases, and displays the total number of test cases in the GUI, and the processor confirms that the desired number of test cases is less than the total number of testcases.

In some cases, the clustering process is a K-means clustering computation.

In some cases, the clustering process is a Density-Based Spatial Clustering of Applications with Noise (DBSCAN) computation.

In some cases, the processor is also configured to initiate executing the subset of test cases.

In some cases, the group of test cases is formatted as a matrix of three columns, comprising the name, the description and the one or more steps, and each row in the matrix is a software test case.

In some cases, the memory further stores an Application Programming Interface (API) configured to obtain the group of test cases from a development software module, and to return the subset of test cases to the development software module.

In some cases, the group of test cases is derived from a group of user reviews of a given software, and wherein a software review application obtains the group of user reviews for the given software.

In at least one broad aspect, a method for identifying test cases is provided. The method is executed in a computing environment comprising one or more processors and memory, wherein the memory stores at least a test application and a NLP pre-trained model. The method includes:
obtaining a group of test cases, each test case comprising a name, a description and one or more steps for testing;
for each test case, processing at least the description and the one or more steps using the NLP pre-trained model to output a vector of numerical values across n-number of dimensions;
compiling a group of vectors corresponding to the group of test cases;
applying a clustering process to the group of vectors to identify a subset of vectors from the group of vectors; and
outputting a subset of test cases corresponding to the subset of vectors.

In some cases, processing at least the description and the one or more steps of a given test case using the NLP pre-trained model includes: obtaining a word vector for each word in the description and the one or more steps; computing a sum of the word vectors, then divide the sum by a number of words in the description and the one or more steps to obtain a resulting vector; and returning the resulting vector as the vector of the given test case.

In some cases, if a new word in the description and the steps is not part of a vocabulary library of the NLP pre-trained model, then the method further includes: generating a unique random word vector corresponding to the new word and storing the new word and the unique random word vector in an Out-Of-Vocabulary library in the NLP pre-trained model.

In some cases, the subset of vectors is a predetermined number stored in the memory.

In some cases, the memory also stores a graphical user interface (GUI), and the method further includes: receiving a desired number of test cases via a GUI element in the GUI, and inputting the desired number of test cases into the clustering process to determine the subset of vectors, where a number of the subset of vectors matches the desired number of test cases.

In some cases, the memory also stores a GUI, and the method further comprising: receive a file that comprises the group of test cases via a first GUI element in the GUI, and receiving a desired number of test cases via a second GUI element in the GUI.

In some cases, the method further includes: automatically determining a total number of test cases in the group of test cases, displaying the total number of test cases in the GUI, and confirming that the desired number of test cases is less than the total number of test cases.

In some cases, the group of test cases is formatted as a matrix of three columns, comprising the name, the description and the one or more steps, and each row in the matrix is a software test case.

In some cases, the memory further stores an API, and the method further includes: obtaining the group of test cases from a development software module via the API, and returning the subset of test cases to the development software module via the API.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for processing application requests in accordance with at least some embodiments;

FIG. 1B is a schematic block diagram of a cloud-based computing cluster of FIG. 1A, including a test application configured to identify a subset test cases from a group of test cases, in accordance with at least some embodiments;

FIG. 2 is a schematic block diagram of a computer in accordance with at least some embodiments;

FIG. 3 is a flow diagram of a process for obtaining test cases using a graphical user interface (GUI), processing the test cases to determining a subset of test cases, and outputting results to the GUI, in accordance with at least some embodiments;

FIG. 4 is a flow diagram of a process for obtaining test cases from a development software module, processing the test cases to identify a subset of test cases, and outputting results to the development software module, in accordance with at least some embodiments;

FIG. 5 is a schematic block diagram of a group of test cases showing example data components, in accordance with at least some embodiments;

FIG. 6 is a schematic block diagram of a group of vectors showing example data components, in accordance with at least some embodiments; and

FIG. 7 is a flow diagram of an example method of determining a subset of test cases from a group of test cases, in accordance with at least some embodiments.

### DETAILED DESCRIPTION

In some cases, it is desirable to provide an artificial intelligence (AI) tool that automatically identifies the most representative test cases from a global set of test cases. In some cases, an AI driven tool is provided to extract a logical subset of test cases through semantic clustering. This ensures the selection of the most representative test cases from the entire global set of test cases according to the specified requirements of a given software (e.g., which is being developed and tested).

In some cases, a web graphical user interface (GUI) is provided to upload/import a file that includes multiple test cases. In some cases, the number of test cases being uploaded are in the tens, or hundreds or thousands. In some cases, each test case includes a name and description of the test case, and one or more steps for executing the test case. The test cases in the file are processed in a NLP preprocessing pipeline to output an intermediate file that includes vector embeddings. Each test case is represented as a vector of numbers. The vectors, which are derived from and correspond to test cases, are then processed using a clustering process (e.g., K-means, mean shift, hierarchical clustering, Density-Based Spatial Clustering of Applications with Noise (DBSCAN), etc.) to cluster semantically similar test cases. The clustering process produces a set of clusters. Within each cluster, a statistically significant one or more vectors are selected. These selected one or more vectors from each cluster are the resulting representative test cases. The AI driven tool then returns the resulting representative test cases to the web GUI for display.

In some cases, the NLP preprocessing pipeline uses words from a given test case name, or description or steps, or a combination thereof, to assign a number of numerical values to the given test case, and the numerical values form a given vector corresponding to the given test case. The number of numerical values in the vector is also referred as the dimension of the vector.

In some cases, the NLP preprocessing pipeline uses a NLP pre-trained model. In some cases, the NLP pre-trained model is a spaCy model in Python, which has 300 floating point numbers forming a vector (i.e., the vector from the spaCy model is embedded into a 300-dimensional space). In some other cases, the NLP pre-trained model is Word2Vec that is pre-trained on a part of Google News, and this model also contains 300-dimensional space. In some cases, the NLP pre-trained Word2Vec model in Gensim is used, whereby Gensim is an open-source Python library for NLP. Other NLP pre-trained models can be used.

In some cases of the NLP pre-trained model, a word is considered a token that is recognized by the NLP pre-trained model (i.e., the word has a vector in the pre-trained models vocabulary). For each given test case, the test case's name, description and/or steps are broken down into its words (also called tokens), and a vector for each word is obtained from the model. The AI driven tool then computes a vector for the entire given test case, by the computation: sum(vectors for the tokens)/len(vectors for the tokens). This means, for example, taking the sum of the vectors corresponding to the tokens, divided by the number of tokens. In some cases, if the token is not part of the NLP pre-trained model's vocabulary (also called Out-of-Vocabulary (OOV)), then the AI driven tool generates a unique random vector and stores it for future use.

In some cases, the statistically significant one or more vectors are selected based on being the closest to the centroid of a given cluster, such as when using K-mean clustering. In some cases, K-means clustering via Principal Component Analysis (PCA) is used, where PCA is used for dimensionality reduction (e.g., transforming a data from a high-dimensional space into a low-dimensional space). PCA is used, for example, to enhance visualization of the vectors.

In some cases, the statistically significant one or more vectors are selected based on a threshold specified by epsilon, such as when using DBSCAN clustering. This returns test cases based on input conditions and the size of the dataset (e.g., the number of test cases) is determined at runtime.

In some cases, the AI driven tool imports data of the test cases in comma separated value (CSV) format, including the headings for test case name, description, and one or more steps for performing the test.

In some cases, the AI driven tool facilitates users to determine the size of the resulting subset based on the available bandwidth.

In some cases, the AI driven tool imports test cases directly from a test management tool. Some examples of test management tools include tools provided by a software development platform under the trade name Jira.

In some cases, the AI driven tool obtains user input to focus and add weightage on specific keywords, for the purposes of executing NLP pre trained model.

In some cases, the AI driven tool automatically modifies the weightage on specific keywords, for the purposes of executing NLP pre trained model, based on heuristics or statistics, or both. For example, previous executions of the AI driven tool on other sets of software test cases for one or more different software projects reveal that certain keywords are important. These same certain keywords are then weighted higher in the NLP model when executing identification process for a current global set of test cases for a current software project.

In some cases, the AI driven tool uses clustering processes other than K-means. Some examples of other clustering processes include mean shift, hierarchical clustering, and DBSCAN.

In some cases, in alternative or in addition to using a web GUI to import/upload test cases, an integrated dev ops software testing environment integrates the AI driven tool for automatically identifying the most representative test cases. The integration can be made, for example, using an application programming interface (API) between the AI driven tool and the dev ops software testing environment.

In some cases, the dev ops software testing environment facilitates users to test software and to add their comments based on the testing. These comments are automatically used to generate a test case. In some cases, there tens of thousands of comments. A collection of these test cases, at least some of which are generated from the user comments, are then sent via the API to the AI driven tool to automatically identify the most representative test cases. These most representative test cases are returned back to the dev ops software testing environment for the users to focus more of their testing.

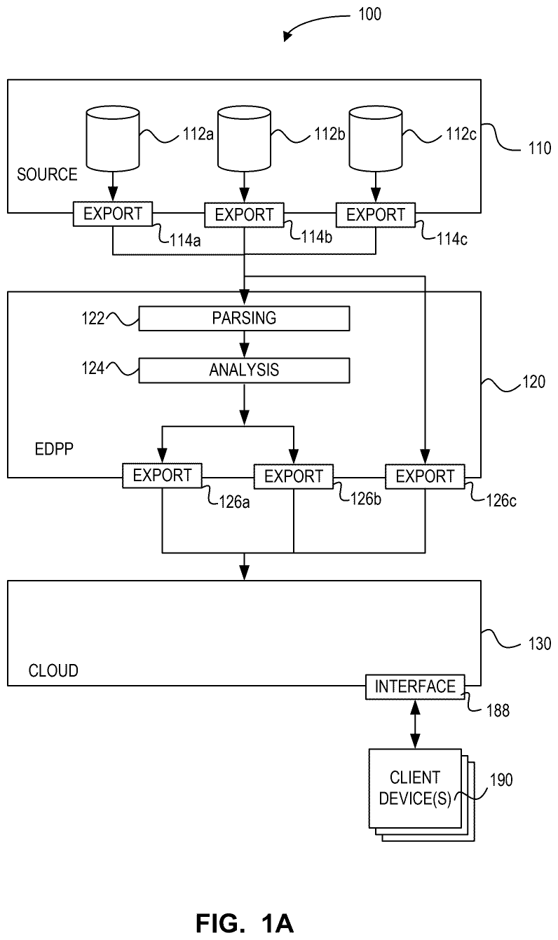

Referring now to FIG. 1A, there is illustrated a block diagram of an example computing system, in accordance with at least some embodiments. Computing system 100 has a source database system 110, an enterprise data provisioning platform (EDPP) 120 operatively coupled to the source database system 110, and a cloud-based computing cluster 130 that is operatively coupled to the EDPP 120. In some cases, this computing system 100 is provided for automated data processing of large data sets, including computing a time series of predicted characteristics of assets identified within the large data sets.

Source database system 110 has one or more databases, of which three are shown for illustrative purposes: database 112a, database 112b and database 112c. One or more the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis. In some cases, the export data may be exported in the form of comma separated value (CSV) data, however other formats may also be used.

EDPP 120 receives source data exported by the export modules 114 of source database system 110, processes it and exports the processed data to an application database within the cloud-based computing cluster 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to an application or group of applications (e.g., a client application) may be exported via reporting and analysis module 124 or an export module 126. In particular, parsed data can then be processed and transmitted to the cloud-based computing cluster 130 by a reporting and analysis module 124. Alternatively, one or more export modules 126a, 126b, 126c can export the parsed data to the cloud-based computing cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 120 may “de-risk” data tables that contain confidential data prior to transmission to cloud-based computing cluster 130. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 130 includes an interface 188, which facilitates data communication with one or more client devices.

Referring now to FIG. 1B, there is illustrated a block diagram of the cloud-based computing cluster 130, showing greater detail of the elements of the cloud-based computing cluster, which may be implemented by computing nodes of the cluster that are operatively coupled.

The components of the cloud-based computing cluster 130 include a data ingestor 132, a test application 140 for determining a subset of test cases from amongst a group of test cases, and a GUI module 160, which are implemented as one or more processing nodes 180 in the cloud-based computing cluster. In some cases, these components are implemented as virtual machines within the cloud-based computing cluster. The test application 140 is also herein interchangeably referred to as the AI driven tool.

In some cases, there are one or more dev ops and testing nodes 170, which are used for software development and testing. The software development and testing in some cases include platforms to obtain developer and user feedback, or obtain automated test feedback, or both. The software development and testing in some cases execute automatic test protocols. Data for test cases 134 can be sent to the test application 140 via an API 168, and the application 140 can return a subset of test cases to the dev ops and testing nodes 170.

In some other cases, data for test cases 134 is sent from a client device 190 via the GUI module 160.

In some other cases, data for test cases 134 is obtained from the EDPP 120 and is ingested via the data ingestor 132.

The test application 140 includes a NLP preprocessing pipeline 142, a clustering module 144, a visualization module 146, a NLP pre-trained model 148, a vectors database 150, and a subset of vectors database 152. These software and data components communicate and share information with each other.

In some cases, a group of test cases is obtained from the data for test cases 134, and the NLP preprocessing pipeline 142 uses the NLP pre-trained model 148 to output a group of vectors that can be stored in the vectors database 150. The clustering module 144 obtains the group of vectors and, using a clustering process, outputs a subset of vectors that can be stored in the subset of vectors database 152. This subset of vectors, along with the group of vectors, can be visually displayed in a graph or other visual representation by the visualization module 146. The test application 140 correlates the subset of vectors to a subset of test cases from amongst the group of test cases, and the subset of test cases is then transmitted to a client device 190, or to the dev ops and testing nodes 170, or to another computing node.

In some cases, the subset of test cases is considered to be the most representative test cases of the entire group of test cases. In some case, identifying these representative test cases using the test application 140 improves accuracy and consistency for identifying the test cases. In some case, identifying these representative test cases using the test application 140 is very quick, and in some cases could occur in the order of seconds. In some cases, this helps to improve software development processes and reduces software testing time.

In some cases, data ingestor 132, the test application 140 and the GUI module 160 reside and operate in the organization's computing environment. For example, the data ingestor 132, the test application 140 and the GUI module 160 reside in a private cloud-based computer cluster. In another example, the data ingestor 132, the application 140 and the GUI module 160 reside on-premise on the organization's computing environment.

It will be appreciated that, while the components shown in FIG. 1B for the cloud-based computing cluster 130 can be implemented with the system 100 in FIG. 1A, in some other cases, the components shown in FIG. 1B are instead implemented in an isolated computing server system. In other words, the components shown in FIG. 1B can be implemented as one or more processing nodes 180 without the EDPP 120 and the source database system 110.

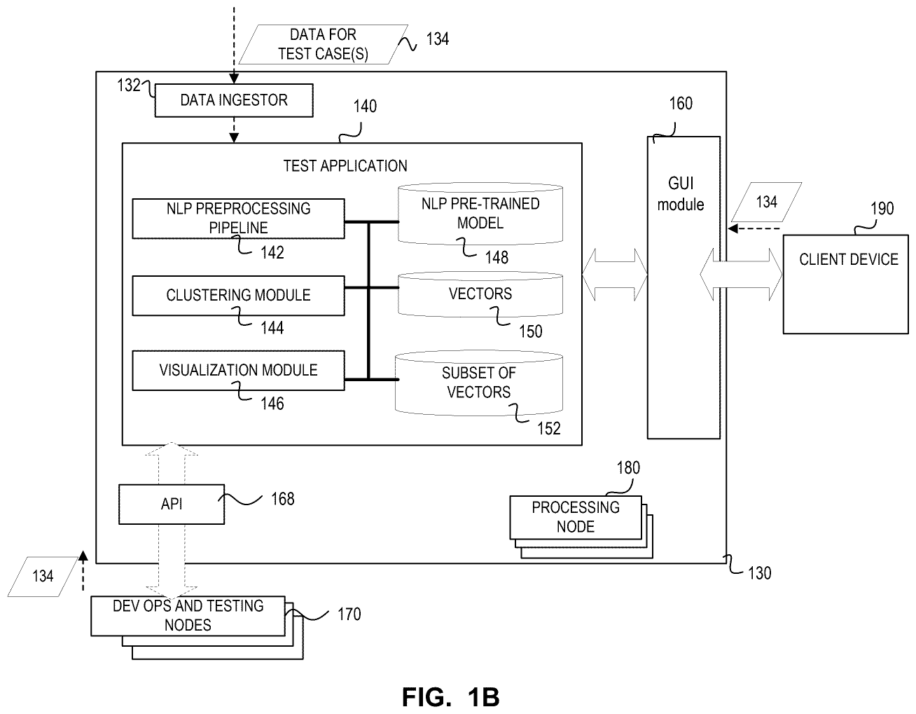

Referring now to FIG. 2, there is illustrated a simplified block diagram of a computer in accordance with at least some embodiments. Computer 200 is an example implementation of a computer such as source database system 110, EDPP 120, processing node 180 of FIGS. 1A and 1B. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data—e.g., within a database—along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. In some cases, the GPUs 214 are used to execute computations for the NLP pre-processing pipeline 142, or the clustering module 144, or both.

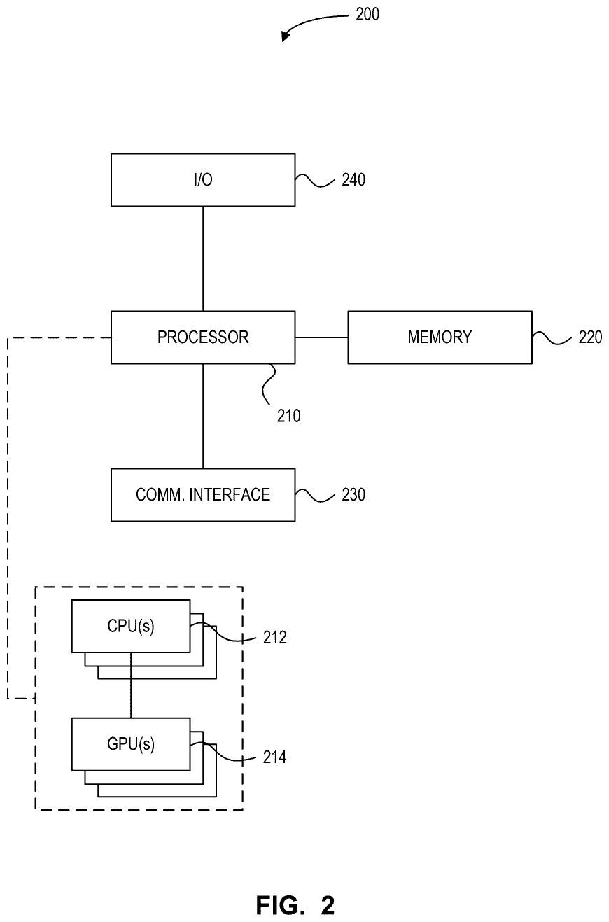

Referring now to FIG. 3, an example computing system and flow process 300 is provided, which includes using a GUI 302. The GUI 302 is used to interface with the test application 140. In some cases, the GUI 302 facilitates the uploading of a file that includes a group of test cases. In some cases, the group of test cases includes a name description and steps. In some cases, a file stores the group of test cases, and in some cases the file is a comma separated value (CSV) file. In some other cases, other file formats can be used.

In the example GUI 302, there is a first GUI element 304 operable to receive a file that comprises the group of test cases. There is also a second GUI element 308 operable to receive a desired number of test cases. In operation, a user uses the first GUI element 304 to upload a file of the group of test cases to the application 140. In some cases, the first GUI element 304 launches a file directory window to search and choose a file. In some cases, the first GUI element 304 allows a user to “drag and drop” a file over the first GUI element 304 for uploading. A name of the file 306 that is to be uploaded may be displayed in the GUI 302.

In the example shown, the user has entered “7” in the second GUI element 308. A third GUI element 310, which when selected by the user, initiates the processing of the file of the group of test cases.

In some cases, the application 140 determines a total number of test cases in the group of test cases, displays the total number of test cases in the GUI, and confirms that the desired number of test cases is less than the total number of testcases.

The group of test cases 320, which may be in a CSV format or some other data format, is processed by the NLP pre-processing pipeline 142. In some cases, the NLP pre-processing pipeline 142 processes, for each test case, at least the description and the one or more steps using the NLP pre-trained model 148 to output a vector of numerical values across n-number of dimensions. As there are a group of test cases, there will be a group of vectors 324 corresponding to the group of test cases. In some cases, the group of vectors 324 are a group of vector embeddings. Vector embeddings use vectors to represent data points in continuous space. For example, each vector (or vector embedding) is a numerical representation of at least the description and the one or more steps of a corresponding given test case.

In some cases, the group of vectors 324 are compiled into a file (e.g., a document or some other file format) and is sent to the clustering module 144.

In some cases, the NLP preprocessing includes obtaining a word vector for each word in the description and the one or more steps of a given test case. The NLP preprocessing further includes computing a sum of the word vectors, then dividing the sum by a number of words in the description and the one or more steps to obtain a resulting vector. The resulting vector is returned as the vector of the given test case.

In some cases, if a new word in the description and the steps is not part of a vocabulary library of the NLP pre-trained model 148, then the NLP preprocessing pipeline 142 generates a unique random word vector corresponding to the new word and stores the new word and the unique random word vector in an Out-Of-Vocabulary library in the NLP pre-trained model 148.

In some case, the NLP preprocessing pipeline 142 includes a tokenizer, a transformer, an entity recognizer (also called “ner”), and a text categorizer (also called “textcat”). The tokenizer is used to segment text into tokens. The transformer is used to facilitate executing a transformer model or some other NLP pre-trained model. In some cases, a transformer model is a neural network that learns context and thus meaning by tracking relationships in sequential data like the words. The entity recognizer is used to detect and label named entities. The text categorizer is used to assign document labels. It will be appreciated that other components can be used to configure the NLP preprocessing pipeline 142.

The group of vectors 324 are obtained by the clustering module 144, and the clustering module 144 applies a clustering process to process the group of vectors.

In some cases, the desired number of test cases is also inputted into the clustering process to determine the subset of vectors 326, where a number of the subset of vectors matches the desired number of test cases. In some cases, the clustering module 144 can select a clustering process from amongst a set of available clustering processes. After computing the clusters, the clustering module 144 identifies a statistically relevant data point (i.e., a vector) in each cluster. The collection of statistically significant data points (e.g., collection of vectors) form the subset of vectors. Some examples of clustering processes include K-means, mean shift, hierarchical clustering, and DBSCAN, which can be used to cluster semantically similar test cases. In some other cases, other types of clustering processes that can be executed by a computing system and which can cluster semantically similar test cases, are stored and used by the clustering module 144.

In some cases, a visualization module 146 will visually plot the group of vectors 324 and the subset of vectors 326 into a graph 328. For example, a data point 329 is shown in FIG. 3, which is statistically significant amongst a given cluster of which it is a member. In the example shown, there are seven such data points that are indicated as statistically significant.

The test application 140 maps a subset of test cases 330 (from the group of test cases) to the subset of vectors 326, and outputs the subset of test cases 330 to the GUI module 160.

The subset of test cases 330 is displayed as a set of results in the GUI 302, including a comparison 312 of the desired number of test cases the total number of test cases, and a listing 314 of at least the names corresponding to the subset of test cases.

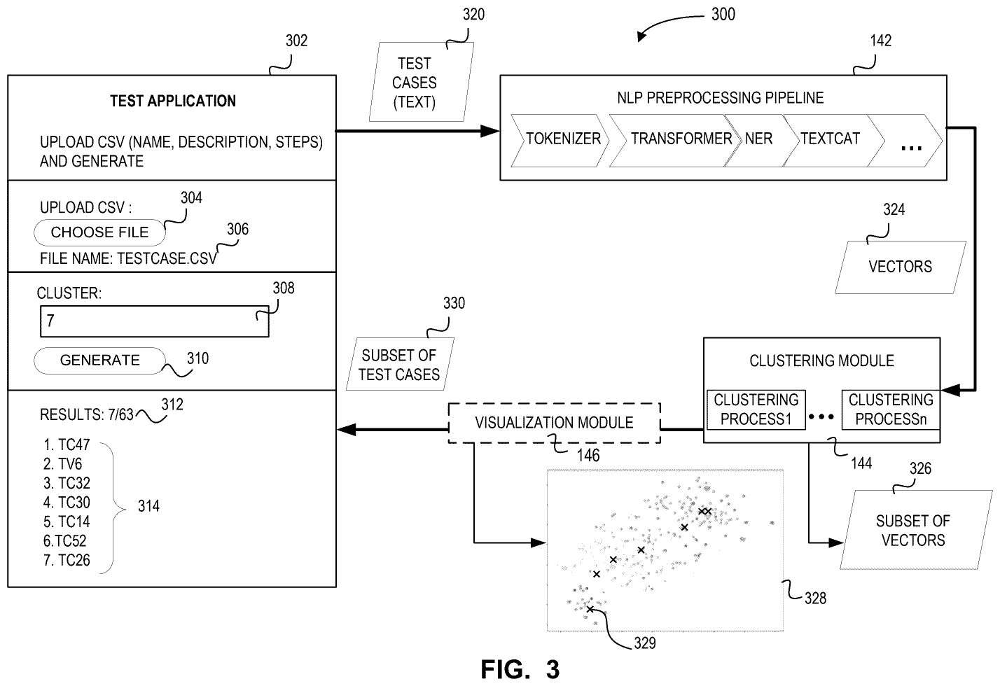

Referring now to FIG. 4, another example system and flow process 400 is provided that is similar to the compared to the computing system and flow process 300 in FIG. 3, but a development software 402 is utilized to obtain a group of test cases 320 and receive a subset of test cases 330.

In some cases, the development software module 402 and the automated testing nodes 404 are part of the dev ops and testing nodes 170.

The development software module 402 is used to establish test cases, either automatically, or manually by a software developer, or both.

In some cases, the group of test cases is derived from a group of user reviews of a given software, and wherein a software review application obtains the group of user reviews for the given software. This software review application can be integrated with, or is in data communication with, the development software module 402.

Continuing with FIG. 4, an API 168 obtains the group of test cases 320 from the development software module 402, and returns the subset of test cases 330 to the development software module 402.

In some cases in which the test cases are automatically executed, the automated testing nodes 404 then automatically execute each of the subset of test cases 320. For example, the one or more steps for a given test case are executed by the automated testing nodes. The results of the testing are provided back to the development software module 402. In some cases, the results of the testing are used to refine the test cases (e.g., generate new test cases, modify existing test cases, delete existing test cases), and a new group of test cases is then sent via the API 168 to the test application 140 to identify a new set of representative test cases.

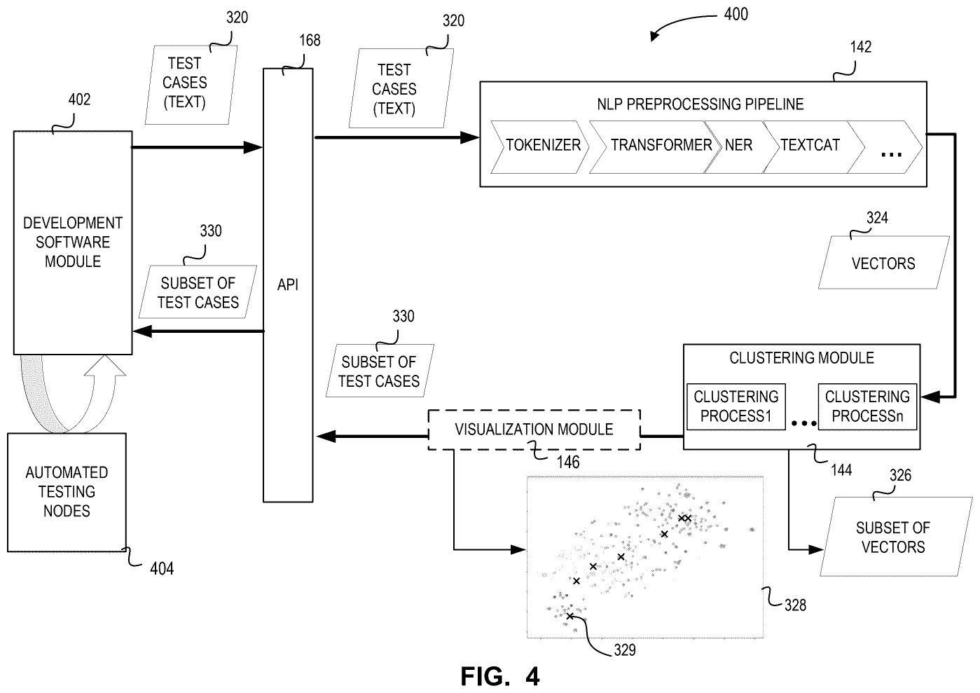

Referring now to FIG. 5, an example embodiment of a group of test cases 500 is shown. Each test case 502 includes a name, a description, and one or more steps for performing the test.

In some cases, the group of test cases 500 is formatted into a file 504. In some cases, the group of test cases is organized into a matrix of three columns, comprising the name, the description and the one or more steps, and each row in the matrix is a software test case. Other approaches for organizing the data can be used.

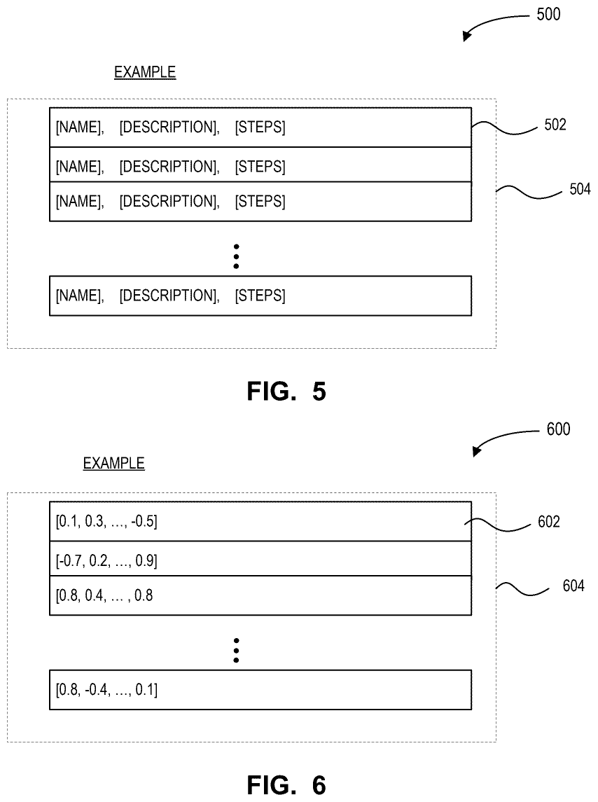

Referring now to FIG. 6, an example embodiment of a group of vectors 600 is shown. Each vector 602 includes numerical values across n-number of dimensions. In some cases, the group of vectors 600 is stored in a document 604 or another type of file format.

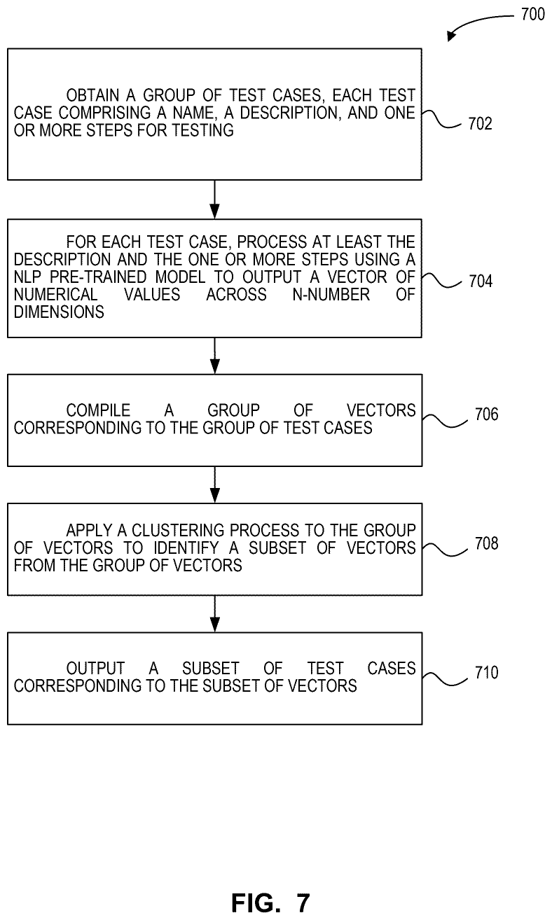

Referring now to FIG. 7, example executable instructions 700 are provided that can be executed by a server system. In some cases, the server system runs the test application 140.

The executable instructions 700 include the following.
Block 702: Obtain a group of test cases. In some cases, each test case comprising a name, a description and one or more steps for testing.
Block 704: For each test case, process at least the description and the one or more steps using a NLP pre-trained model to output a vector of numerical values across n-number of dimensions.
Block 706: Compile a group of vectors corresponding to the group of test cases.
Block 708: Apply a clustering process to the group of vectors to identify a subset of vectors from the group of vectors.
Block 710: Output a subset of test cases corresponding to the subset of vectors.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g. 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A server system for identifying test cases, the server system comprising:
a memory storing a Natural Language Processing (NLP) pre-trained model, a network interface, and a processor, the processor operably coupled to the memory and the network interface, the processor configured to:
obtain a group of test cases, each test case comprising a name, a description and one or more steps for testing;
for each test case, process at least the description and the one or more steps using the NLP pre-trained model to output a vector of numerical values across n-number of dimensions;
compile a group of vectors corresponding to the group of test cases;
apply a clustering process to the group of vectors to identify a subset of vectors from the group of vectors; and
output a subset of test cases corresponding to the subset of vectors.

2. The server system of claim 1, wherein the processor is configured to process at least the description and the steps of a given test case using the NLP pre-trained model by at least:
obtaining a word vector for each word in the description and the one or more steps;
computing a sum of the word vectors, then divide the sum by a number of words in the description and the one or more steps to obtain a resulting vector; and
returning the resulting vector as the vector of the given test case.

3. The server system of claim 2, wherein if a new word in the description and the one or more steps is not part of a vocabulary library of the NLP pre-trained model, then the processor is configured to: generate a unique random word vector corresponding to the new word and store the new word and the unique random word vector in an Out-Of-Vocabulary library in the NLP pre-trained model.

4. The server system of claim 1, wherein the subset of vectors is a predetermined number stored in the memory.

5. The server system of claim 1, wherein the memory also stores a graphical user interface (GUI) that includes a GUI element operable to receive a desired number of test cases, and the desired number of test cases is inputted into the clustering process to determine the subset of vectors, where a number of the subset of vectors matches the desired number of test cases.

6. The server system of claim 1, wherein the memory also stores a GUI that includes a first GUI element operable to receive a file that comprises the group of test cases, and a second GUI element to operable to receive a desired number of test cases.

7. The server system of claim 6, wherein the processor is configured to automatically determine a total number of test cases in the group of test cases, and displays the total number of test cases in the GUI, and the processor confirms that the desired number of test cases is less than the total number of testcases.

8. The server system of claim 1, wherein the clustering process is a K-means clustering computation.

9. The server system of claim 1, wherein the group of test cases is formatted as a matrix of three columns, comprising the name, the description and the one or more steps, and each row in the matrix is a software test case.

10. The server system of claim 1, wherein the memory further stores an Application Programming Interface configured to obtain the group of test cases from a development software module, and to return the subset of test cases to the development software module.

11. A method for identifying test cases, the method executed in a computing environment comprising one or more processors and memory, wherein the memory stores at least a test application and a Natural Language Processing (NLP) pre-trained model, and the method comprising:
obtaining a group of test cases, each test case comprising a name, a description and one or more steps for testing;
for each test case, processing at least the description and the one or more steps using the NLP pre-trained model to output a vector of numerical values across n-number of dimensions;
compiling a group of vectors corresponding to the group of test cases;
applying a clustering process to the group of vectors to identify a subset of vectors from the group of vectors; and
outputting a subset of test cases corresponding to the subset of vectors.

12. The method of claim 11, wherein processing at least the description and the one or more steps of a given test case using the NLP pre-trained model comprises:
obtaining a word vector for each word in the description and the one or more steps;
computing a sum of the word vectors, then divide the sum by a number of words in the description and the one or more steps to obtain a resulting vector; and
returning the resulting vector as the vector of the given test case.

13. The method of claim 12, wherein if a new word in the description and the steps is not part of a vocabulary library of the NLP pre-trained model, then the method further comprises: generating a unique random word vector corresponding to the new word and storing the new word and the unique random word vector in an Out-Of-Vocabulary library in the NLP pre-trained model.

14. The method of claim 11, wherein the subset of vectors is a predetermined number stored in the memory.

15. The method of claim 11, wherein the memory also stores a graphical user interface (GUI), and the method further comprising: receiving a desired number of test cases via a GUI element in the GUI, and inputting the desired number of test cases into the clustering process to determine the subset of vectors, where a number of the subset of vectors matches the desired number of test cases.

16. The method of claim 11, wherein the memory also stores a GUI, and the method further comprising: receive a file that comprises the group of test cases via a first GUI element in the GUI, and receiving a desired number of test cases via a second GUI element in the GUI.

17. The method of claim 16, further comprising: automatically determining a total number of test cases in the group of test cases, displaying the total number of test cases in the GUI, and confirming that the desired number of test cases is less than the total number of test cases.

18. The method of claim 11, wherein the group of test cases is formatted as a matrix of three columns, comprising the name, the description and the one or more steps, and each row in the matrix is a software test case.

19. The method of claim 11, wherein the memory further stores an Application Programming Interface (API), and the method further comprising: obtaining the group of test cases from a development software module via the API, and returning the subset of test cases to the development software module via the API.

20. A non-transitory computer readable medium storing computer executable instructions which, when executed by at least one computer processor, cause the at least one computer processor to carry out a method for identifying test cases, the non-transitory computer readable medium further comprising a test application and a Natural Language Processing (NLP) pre-trained model, and the method comprising:
obtaining a group of test cases, each test case comprising a name, a description and one or more steps for testing;
for each test case, processing at least the description and the one or more steps using the NLP pre-trained model to output a vector of numerical values across n-number of dimensions;
compiling a group of vectors corresponding to the group of test cases;
applying a clustering process to the group of vectors to identify a subset of vectors from the group of vectors; and
outputting a subset of test cases corresponding to the subset of vectors.
